(19) United States
(12) Patent Application Publication
(10) Pub. No.: US 2006/0185201 A1
(43) Pub. Date: Aug. 24, 2006

(54) Greeting card and gift box composite

(76) Inventors: Emil E. Fachon III, East Greenwich, RI (US); Wendy N. Fachon, East Greenwich, RI (US); Manuel J. Mendes, Johnston, RI (US)

Correspondence Address: Richard D Zimmerman;Chace Ruttenberg & Freedman, One Park Row, Suite 300, Providence, RI, 02903, US

(21) Appl. No.: 10/547,856

(22) PCT Filed: Mar. 16, 2004
(86) PCT No.: PCT/US04/08122

§ 371 Date: Sep. 2, 2005

Related U.S. Application Data
(60) Provisional application No. 60/456,008, filed on Mar. 19, 2003.

(51) Int. Cl. G09F 1/00

(52) U.S. Cl. 40/124.06; 40/312

(57) ABSTRACT

A greeting card and gift box composite comprising a gift box having a greeting wall with an integral greeting card cover that opens to reveal an interior message card affixed inside the gift box. The greeting card cover is created by partially cutting through the greeting wall surface while leaving a scored line hinge and breakaway attachment points. The greeting card cover is opened by using a finger catch to lift the greeting card cover, detaching the breakaway attachment points, then hinging open the greeting card cover to view the interior message card. The interior message card is aligned and removably attached to the interior greeting wall surface, substantially covering the greeting wall opening, while making the interior message card visible when the greeting card cover is opened. The greeting card and gift box composite may be reused by removing the used interior message card and installing a new one.

### CROSS-REFERENCE AND PRIORITY

Applicants reference and claim the benefit of prior filed U.S. Provisional Patent Application Ser. No. 60/456,008, filed Mar. 19, 2003 and titled Box With Integrated Greeting Card.

### BACKGROUND

The present invention relates to a new gift presentation box that includes an integrated greeting card. More specifically, this invention relates to a gift box that includes a greeting card formed in the cover or other wall thereof, wherein a flap is cut into the box material to form the greeting card cover and an interior message card is affixed inside the gift box so as to be viewable when the greeting card cover is opened.

In traditional gift giving, a gift is placed within a box, the box is wrapped in decorative paper, and a separate greeting card is attached thereto. This practice consumes a large quantity of paper material, time is spent in assembly, and each separate packaging element has its own cost. To reduce paper consumption and the time and cost required to produce an attractive gift package, attempts have been made to combine printed gift boxes with some form of greeting.

One attempt employs a full-sized supplemental top overlay which serves as a greeting card cover and which opens to reveal a greeting imprinted on the box cover, or a greeting printed on a separate card insert which is permanently attached to the box cover. Such attempts which use a full-sized overlay top, and which print a greeting to be personalized directly onto the box surface, or which permanently affix a greeting card insert to the box, use excessive material because they do not integrate the card cover into a single-layer box construction, and they cannot be used more than once.

Another known attempt combines a greeting card holder and gift box employing a cutout cover feature in which two tabs are pulled to release a section of the box cover. After the tabs are removed and discarded, the cover section is pulled open. Such boxes require removal of material to open the cover, thus disfiguring the surface and preventing reuse, and the cover serves only as a box cover, not as an integral greeting card cover. The greeting card must be provided separately.

What is needed is new type of gift box with integrated greeting card, a greeting card and gift box composite, that uses the material of the gift box itself—the same single-layer material that would otherwise be part of the box if no greeting card were present—for the purpose of cutting a flap that forms a greeting card cover, where the greeting card cover, the outside of which may be decoratively printed to render a greeting card face—acts as a cover for the integrally formed greeting card, and where the interior message of the greeting card is printed on card stock and affixed directly to the underside of the area surrounding the greeting card cover so as to make the interior message readable when the greeting card cover is open. What also is needed is the integration of both a gift box and greeting card to provide a reusable product wherein the interior message card is affixed with an easily removable adhesive so that the interior message card can be removed and replaced thereby facilitating reuse of the gift box with greeting card cover.

### SUMMARY OF THE INVENTION

In accordance with the present invention, a gift box is provided that integrates a greeting card in the cover or other wall thereof. As can be seen in the attached drawings, the greeting card and gift box composite is shown with a flap cut therein to form the integral greeting card cover. The greeting card cover is a contiguous and decorative element that may be die-cut and hinge-scored into a larger box surface, such as a box lid in the case of a typical two-piece box construction, or, more generically, into a greeting wall, which could be any surface of a one- or multi-piece box construction that has sufficient area to integrate a greeting card.

The greeting wall is formed from single-layered material. Single layered being any paper, cardboard, corrugated cardboard, card stock or similar material, including those with metal and plastic laminates thereon that would not be separated or delaminated in normal use. The material preferably has ornamental decorative indicia printed thereon. Clearly, the printing can be tailored as required to suit numerous events and personal tastes, and the gift box may vary in size and shape to suit a variety of gifts, so long as it has one greeting wall of sufficient area and accessibility to integrate the greeting card.

The interior message of the greeting card is printed onto separate card stock that can be personalized and is typically affixed directly to the area surrounding the underside of the opening in the greeting wall, this opening being defined by the greeting card cover. The interior message card is aligned beneath the greeting card cover on the interior greeting wall surface of the box by matching up registration arrows that are printed on the back of the interior message card and the inside of the box so as to make the interior message readable when the greeting card cover is opened. The interior message card may be removably attached using an adhesive, such as a low-tack shielded adhesive, thus allowing the gift recipient to reuse the gift box with greeting card cover by removing the used interior message card, flexing the greeting card cover back into place, then personalizing and affixing a new interior message card.

### BRIEF DESCRIPTION OF DRAWINGS

These and other features, aspects and advantages of the present invention will become better understood with regard to the following description, appended claims, and accompanying drawings where:

FIG. 1 shows an exploded perspective view of a greeting card and gift box composite;

FIG. 2 shows a perspective view of an assembled greeting card and gift box composite with greeting card cover open;

FIG. 3 shows a plan view of an interior message card with adhesive and adhesive shield;

FIG. 4 shows a plan view of the interior greeting wall surface of an unassembled gift box lid with an unattached interior message card;

FIG. 5 shows a plan view of the interior greeting wall surface of an unassembled gift box lid with an attached interior message card;

FIG. 6 shows a plan view of an alternative unassembled greeting card and gift box composite;

FIG. 7 shows a perspective exploded view of an alternative greeting card and gift box composite;

FIG. 8 shows a perspective view of an alternative greeting card and gift box composite with greeting card cover open; and

FIG. 9 shows a perspective view of an alternative greeting card and gift box composite;

FIG. 10 shows a plan view of an interior message card with slits, to allow mounting of a photograph;

FIG. 11 shows a plan view of an interior message card with photograph mounted;

FIG. 12 shows a perspective view of the reusable gift box with greeting card cover portion of a one-piece greeting card and gift box composite;

FIG. 13 shows a perspective view of the reusable gift box with greeting card cover elements of a two-piece greeting card and gift box composite; and

FIG. 14 shows an enlarged detail of the greeting card cover lower right corner before the breakaway attachment points are detached;

FIG. 15 shows an enlarged detail of the open greeting card cover lower right corner after the breakaway attachment points are detached; and

FIG. 16 shows an enlarged detail of the closed greeting card cover lower right corner, where torn fibers at the tips of the remnants of the breakaway attachment points interlock to form a paper clasp.

### DETAILED DESCRIPTION

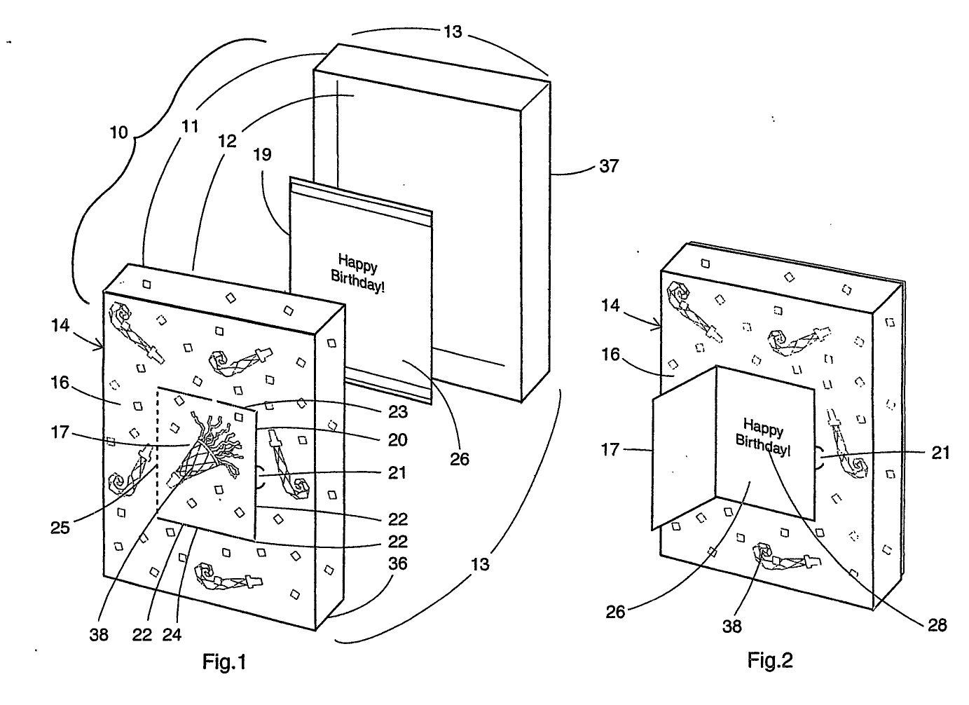

As shown in FIGS. 1, 2, 7 & 9, the greeting card and gift box composite 10 comprises a gift box 11 having an inside of box 12 and an outside of box 13, a greeting wall 14 of single-layer construction, and an interior message card 19. The gift box 11 may be of the traditional one or two-piece construction, or may be of multiple pieces and includes a variety of types of containers suitable for holding gifts. The greeting wall has sufficient surface area to integrate a greeting card cover 17 within greeting wall 14 and accommodate an interior message card 19 on the interior greeting wall surface 15. An interchangeable interior message card 19 is attached to the interior greeting wall surface 15, wherein the greeting card cover 17 and interior message card 19 form a complete greeting card. The greeting card cover 17 is composed of, and gives dual purpose to, the single-layer material of the greeting wall 14. As shown in FIGS. 2 & 8, portions of the interior message card front 26 may be viewed through the greeting wall opening 18 by opening the greeting card cover 17, such as by inserting a fingernail under the outside edge of card cover 20 at the finger catch 21 and then lifting. Breakaway attachment points 22 located along the outside edge of card cover 20, the top edge 23, and the bottom edge 24 of the greeting card cover 17 are used to hold the greeting card cover 17 in place during manufacture. As the card cover is lifted, the breakaway attachment points 22 neatly separate as the card cover hinges up along the scored line hinge 25.

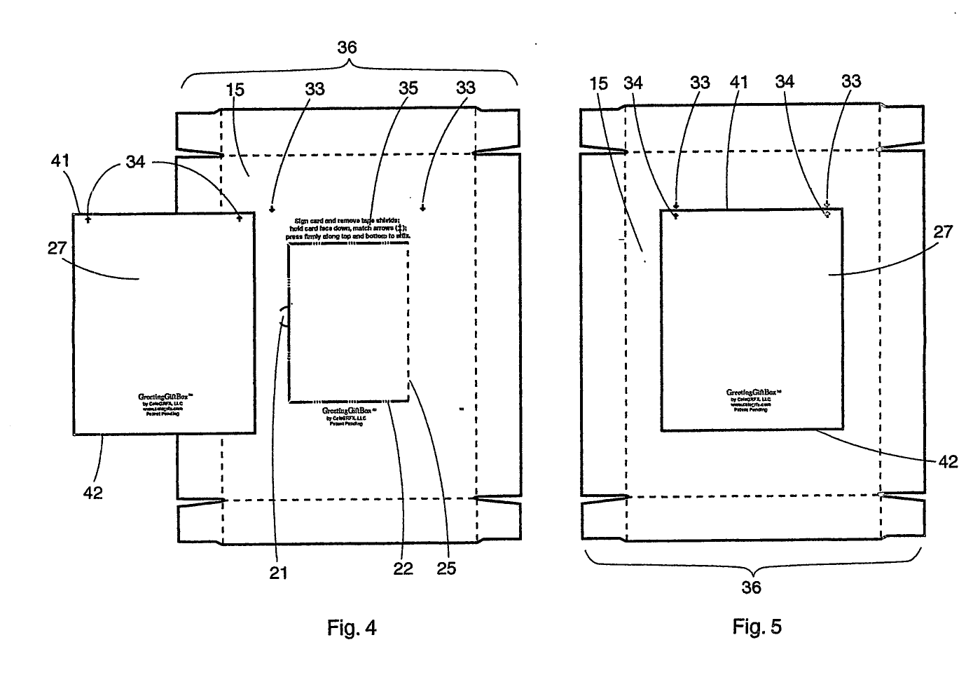

As shown in FIG. 1, the greeting wall 14 has an exterior greeting wall surface 16. As shown in FIGS. 4 & 5, the greeting wall 14 has an interior greeting wall surface 15. The greeting wall is made of a single layer of material in that the interior greeting wall surface 15 and exterior greeting wall surface 16 are the opposing surfaces of a single layer of material which will not be separated or divided to create another interior or exterior surface in ordinary use by the user. The greeting wall may be constructed from a variety of materials of varying thickness which may be manufactured from multiple layers of fibers, as in the case of an ordinary cardboard gift box, or from multiple layers of paper as in corrugated cardboard, and including materials with specialty laminates thereon to produce a variety of decorative effects. Such materials however, are presented to the user as a single layer of material in which two surfaces of the single layer are the interior greeting wall surface 15 and exterior greeting wall surface 16, and the user will not ordinarily delaminate the fibers, corrugated cardboard, or components of a single layer greeting wall 14. The greeting wall has no exterior overlay or cover that conceals the greeting wall 14.

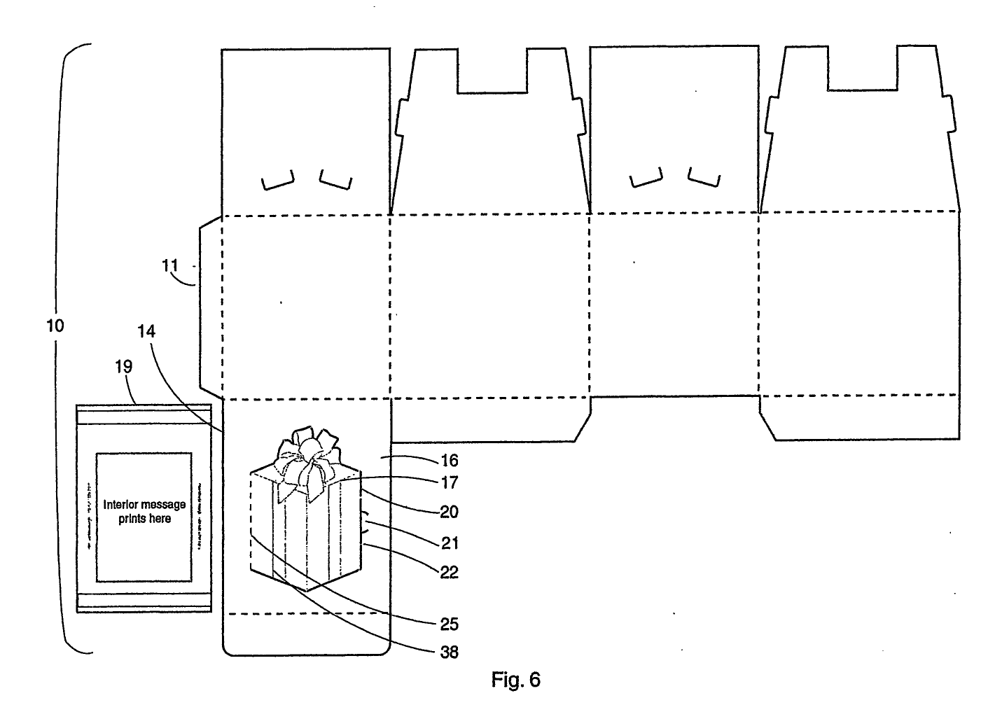

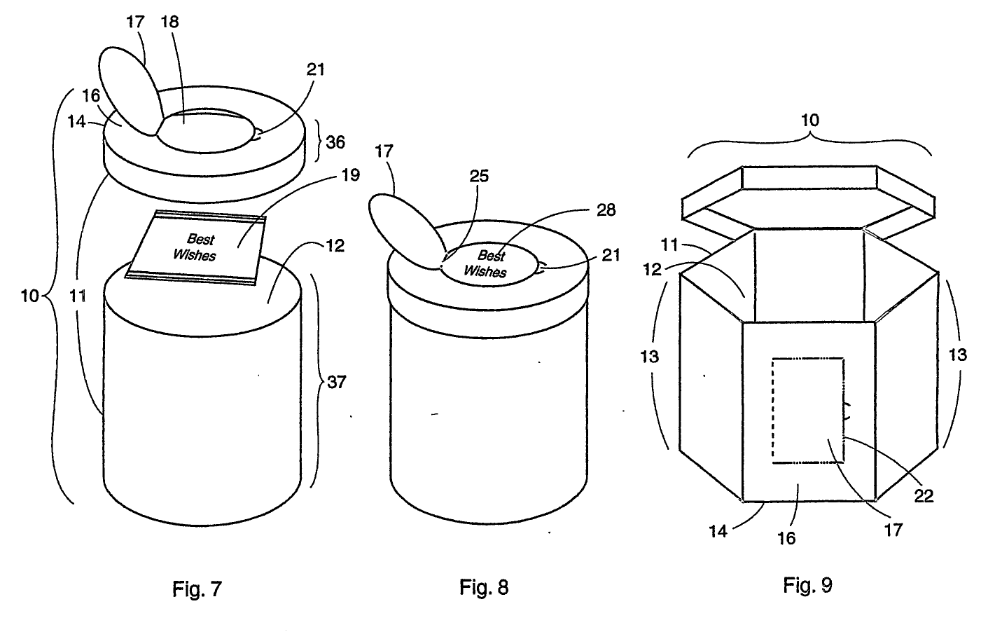

An area of the single layer greeting wall 14 is made to open to create the greeting card cover 17, preferably by die-cutting, though numerous other means of cutting, including shearing, slicing, razor knifing, or partial cut-through could be used. The greeting card cover 17 is preferably formed by die-cutting three edges, an outside edge of card cover 20, the top edge 23, and the bottom edge 24 to create a well known rectangular greeting card cover 17, as shown in FIGS. 1 & 9. The greeting card cover 17 also could be formed in a variety of multi-sided and curved shapes, examples of which are shown in FIGS. 6 & 8, all within the scope of this invention. The greeting card cover 17 is an integral and contiguous part of the greeting wall 14 and hence the gift box itself. Being cut to permit opening along the scored line hinge 25, the greeting card cover 17 pivots along said scored line hinge 25. Thus the greeting card cover 17 is attached to and is part of the single layer material which comprises the greeting wall 14. When opened, the greeting card cover 17 creates a greeting wall opening 18 in the greeting wall 14 as shown in FIG. 7. The greeting wall opening 18 would permit physical communication through the greeting wall in the absence of the interior message card 19, though the greeting card and gift box composite is not intended for use in this manner.

The greeting wall 14 includes an area to accommodate the interior message card 19, having sufficient flatness to allow the interior message card 19 to be easily attached to the interior greeting wall surface 15, and to prevent inadvertent separation of the interior message card 19 from the interior greeting wall surface 15 during normal use. The amount of acceptable non-flatness of the greeting wall 14 surrounding the greeting card cover 17 will vary depending on the flexibility of the interior message card 19 and the nature of the removable attachment means 29 described below.

The gift box 11 may be decoratively printed, including with indicia 38 on all visible surfaces, and may be of various sizes and shapes—including one- and multiple-piece constructions—provided the gift box has a greeting wall 14 of sufficient area to integrate a greeting card cover 17. Similarly, the greeting card cover 17 can include additional distinct ornamental or other indicia 38 printed thereon to indicate the greeting card element and should be of a shape and size suitable to the gift box. Examples of gift box with greeting card cover alternatives are shown in FIGS. 1, 6, 7, 8, 9, 12 & 13.

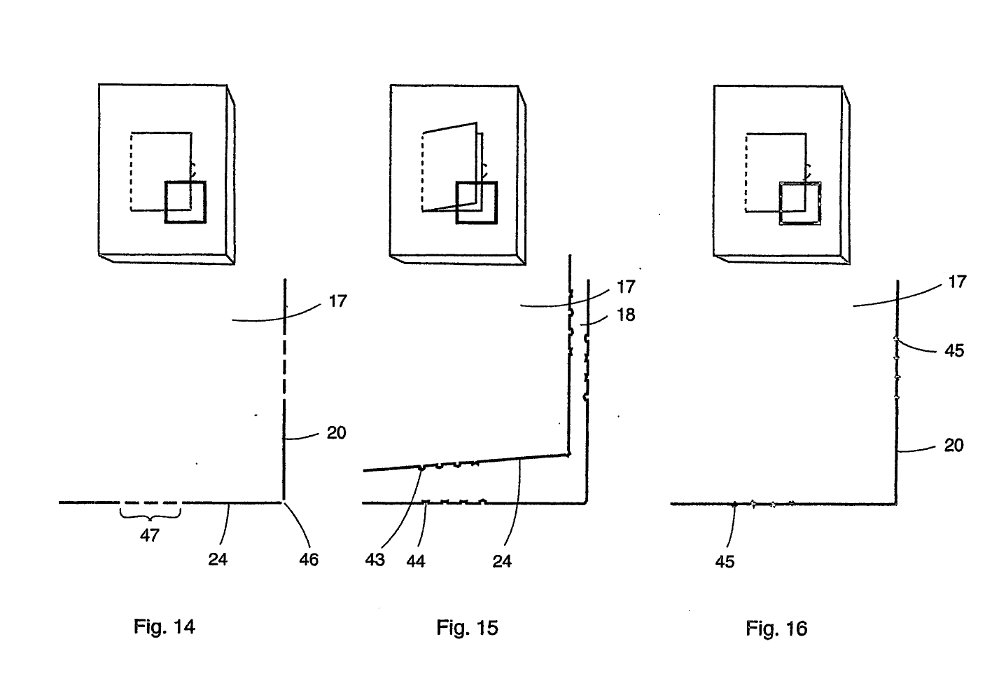

As shown in FIGS. 1, 4, 6, 9, 14, 15, & 16, the present invention preferably employs a minimal number of breakaway attachment points 22 which are points of residual attachment around the die-cut edges 20, 23, & 24 of the greeting card cover 17, these breakaway attachment points 22 being very small nicks 46, preferably approximately 0.025 to 0.035 inches (0.6 to 0.9 mm) in length, or segments of perforation 47 made up of 4 to 5 of said nicks 46 closely grouped within a span of approximately 0.375 inches (9.5 mm). The number and spacing of the breakaway attachment points 22 will vary with the type and thickness of the greeting wall material and the size of the greeting card cover 17. In the current best mode, for a card cover of approximately 4 inches (10.2 cm) by 5 inches (12.7 cm) within a greeting wall made of 18 point virgin SBS card stock, there are three segments of perforation 47 on both the top edge 23 and the bottom edge 24 as well as two segments of perforation 47 on the outside edge of card cover 20, these segments of perforation 47 being approximately equally spaced from each other, as measured along the edges 20, 23 & 24, and one nick 46 at each of the two corners where the outside edge of card cover 20 joins the top edge 23 and the bottom edge 24. The number, nature, and spacing of breakaway attachment points 22 should be selected to prevent the greeting card cover 17 from opening during manufacture, to permit easy opening by the gift recipient, and to help hold the greeting card cover 17 in place when the gift box with greeting card cover element 40 of a greeting card and gift box composite 10 is reused.

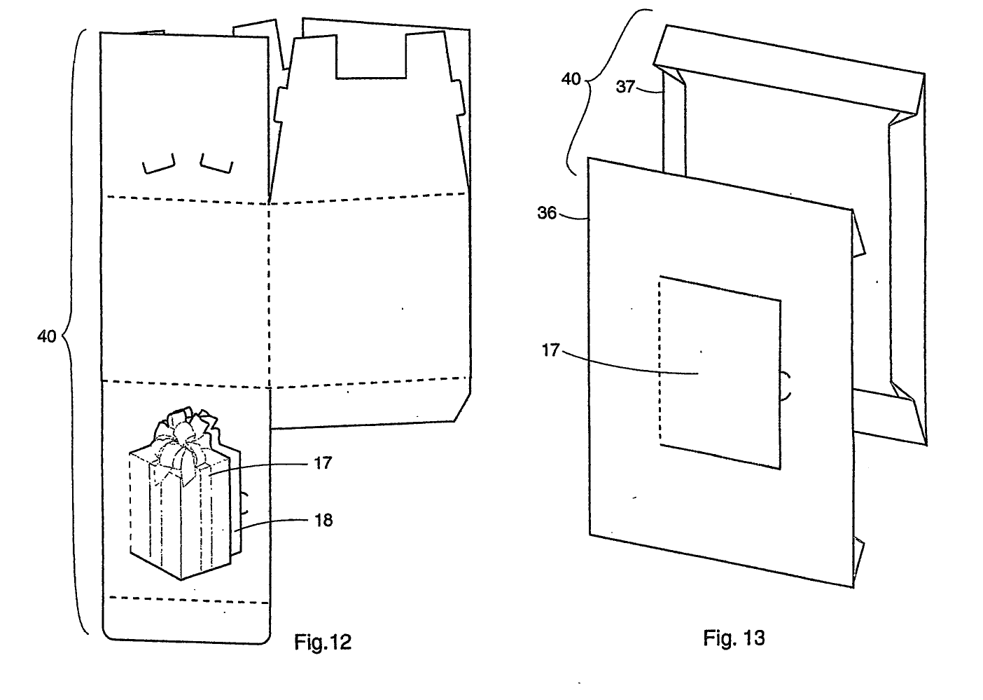

When the greeting card cover 17 is first opened, the breakaway attachment points 22 will neatly separate without loss of material, thus allowing reuse of the gift box with greeting card cover element 40 shown in FIGS. 12 & 13, the gift box with greeting card cover element 40 being the gift box with greeting card composite 10 without the interior message card 19. This may be done by removing a used interior message card 19, flexing the greeting card cover 17 sufficiently into the inside of box 12 to hold itself angled in slightly and affixing a new interior message card 19 to lift and hold the greeting card cover 17 within the perimeter of the greeting wall opening 18. The material used to construct the gift box preferably has sufficient elastic memory to hold the greeting card cover 17 closed and in tension against the new interior message card 19. As shown in FIG. 16, when the torn fibers at the tips of the greeting card cover attachment point remnants 43 and greeting wall attachment point remnants 44, are realigned to touch each other, as when installing a new interior message card 19, they will interlock to form a paper clasp 45 and further assist in holding the greeting card cover 17 in place. Thus the gift box with greeting card cover element 40 of the greeting card gift box composite 10 can be reused one or more times, like a gift bag.

The interior message card 19 has an interior message card front 26 and an interior message card back 27 and may include an interior message 28 printed or written on the interior message card front 26. The interior message 28 will be viewable through the greeting wall opening 18 when the greeting card cover 17 is open. A removable attachment means 29 affixes the interior message card 19 to the interior greeting wall surface 15. The preferred removable attachment means 29 is a low-tack/medium-tack film adhesive with an adhesive shield 30 to cover the adhesive before the interior message card 19 is affixed to the interior greeting wall surface 15. Shielded adhesives are well known and should be selected for compatibility with the materials used in constructing both the interior message card 19 and the gift box with greeting card cover element 40 of a greeting card and gift box composite 10. The preferred adhesive will remain permanently affixed to the interior message card 19 while providing removable adhesion to the interior greeting wall surface 15. The removable attachment means 29 also may be a variety of known means, including tape, non-permanent glue or rubber cement, and mechanical fasteners such as brackets, Velcro®, tabs, or clips.

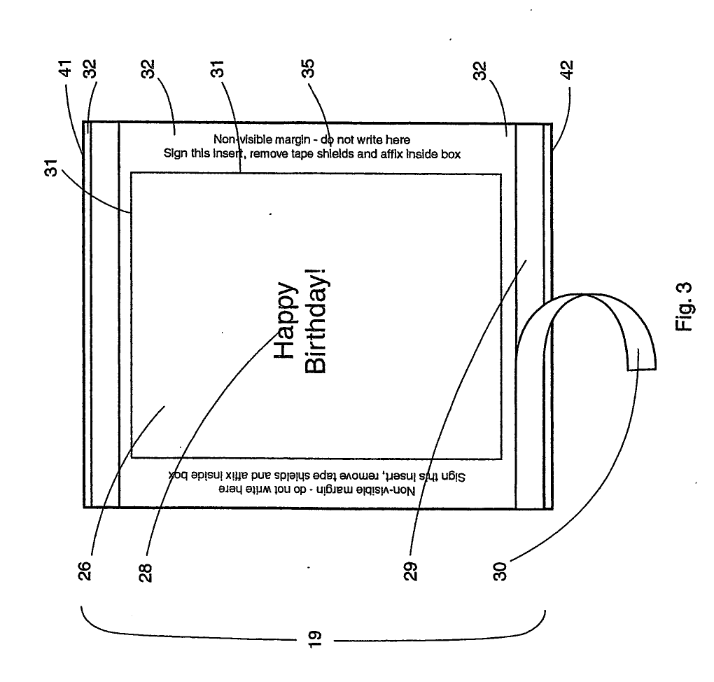

As shown in FIG. 3, the shielded adhesive preferably is placed in strips along the interior message card top edge 41 and interior message card bottom edge 42 of the interior message card front 26 within the no-write margins 32 of the interior message card front 26. The adhesive may be placed anywhere within the no-write margins 32, but along the top edge and bottom edge is preferable. The interior message card 19 is then affixed to the interior greeting wall surface 15, with the removable adhesive contacting the interior greeting wall surface 15, preferably at right angles to the outside edge of card cover 20 and the scored line hinge 25. This permits easier opening of the greeting card cover 17 by allowing the greeting wall 14 to flex inward sufficiently along the outside edge of card cover 20 adjacent to the finger catch 21 to insert a fingernail or similar lever underneath the outside edge of card cover 20 without causing strain to the adhesive that might otherwise detach the interior message card 19. The finger catch 21 provides further relief in the greeting wall 14 adjacent to the outside edge of card cover 20 to allow the greeting wall 14 to flex. The finger catch 21 preferably is cut into the greeting wall 14 adjacent to the middle of the outside edge of card cover 20. The finger catch 21 preferably approximates a semi-circle, cut approximately on a ¼″ (6 mm) radius with approximately ⅓^{rd} of the circumference left uncut at 90° of arc, leaving the finger catch 21 permanently attached to the greeting wall 14 at the uncut portion of the circumference.

During user assembly, the interior message card 19 may be personalized, the adhesive shields 30 removed as shown in FIG. 3, and the interior message card aligned on the inside of box 12 on the interior greeting wall surface 15 as shown in FIGS. 4 & 5. Interior message card registration arrows 34 printed on the interior message card back 27 are aligned with interior registration arrows 33 on the interior greeting wall surface 15. Assembly instructions 35 may be printed in the no-write margins 32 of the interior message card front 26 or on the interior greeting wall surface 15 to instruct the user in aligning the registration arrows and affixing the interior message card 19. Affixing the interior message card 19 to the interior greeting wall surface 15 preferably conceals the assembly instructions 35 to present an uncluttered interior greeting wall surface 15 to the gift recipient. Thus, the interior message card 19 is properly aligned and affixed to the interior greeting wall surface 15 immediately surrounding the greeting wall opening 18 so the interior message 28 is readable through the greeting wall opening 18 when the greeting card cover 17 is opened.

Additionally, as shown in FIG. 3, a printed margin border 31 on the interior message card front 26 defines no-write margins 32 in which the user ordinarily will not write any personal greeting or message, since the no-write margins 32 is the area of the interior message card that will not be visible through the greeting wall opening 18 when the greeting card cover 17 is open. Thus, the no-write margins 32 constitutes a portion of the interior message card 19 extending beyond the dimensions of the greeting card cover 17 to prevent unsightly gaps between the interior message card 19 and the greeting wall opening 18.

It also is possible to print custom interior message cards on demand using commonly available printer and computer technology, making the present invention well suited to retailers who wish to offer their customers a cost-effective and customizable gift packaging alternative. Standard greetings in which a variety of occasions can be specified, such as “Wedding”, “Anniversary”, “Happy Birthday”, or “Congratulations” can be customized on demand with personalized information, including the name of the recipient, the gift-giver, and information that would otherwise be particular to a specific event.

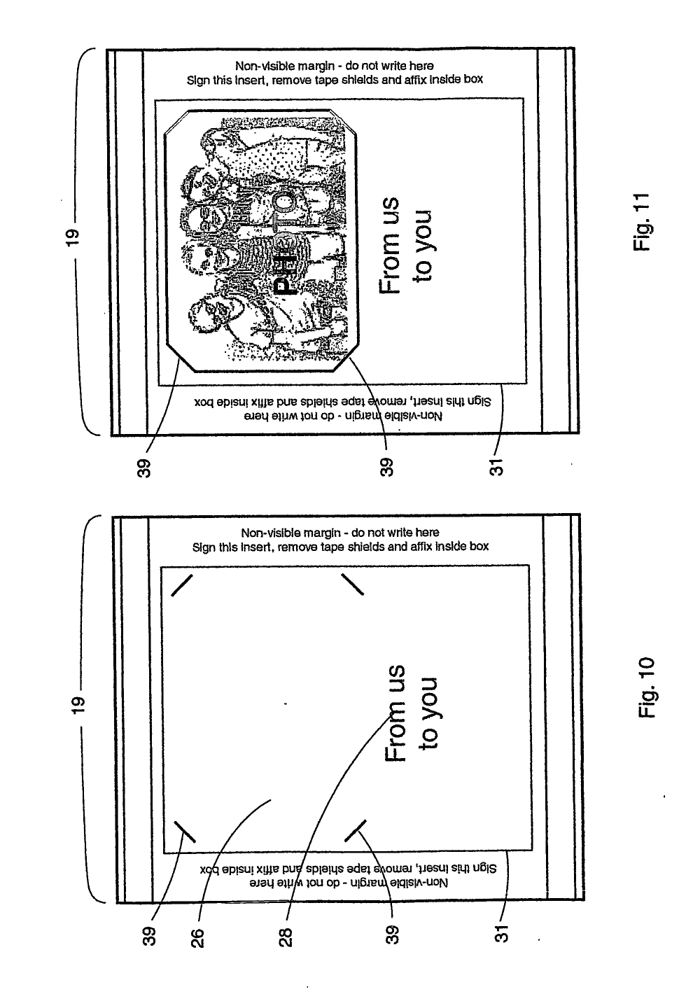

The gift box 11 used in a greeting card and gift box composite 10 may be a traditional two-piece rectangular box as shown in FIG. 1, having a gift box lid 36 and a gift box bottom 37. While particular box shapes are shown, the present invention anticipates implementation in a variety of sizes and shapes, including but not limited to cylinders as shown in FIGS. 7 & 8, polyhedrons as shown in FIG. 9, 1-piece box constructions as shown in FIG. 6, and multiple-piece constructions. The greeting card and gift box composite 10 can be formed from a variety of materials, including paper, laminated paper, virgin and recycled papers, card stocks, coated paper, cardboard, corrugated cardboards, and similar materials, including those with metal or plastic laminates. Printing of indicia 38 and interior messages 28 can be modified to suit a variety of tastes and occasions. The interior message card 19 typically would be printed on an uncoated card stock to enhance write-ability, but it may also be rendered in a variety of other papers or card stocks for special interior message card 19 treatments. As shown in FIGS. 10 & 11, the interior message card 19 may also furnish mounting slits 39 to enable the gift giver to mount a photograph on the interior message card 19 as part of the interior message 28 to be revealed when the gift recipient opens the greeting card cover 17.

The greeting card and gift box composite 10 is well suited to present day gift giving where the gift giver is often pressed for time but still wants to present an attractive and customized gift package. Using a greeting card and gift box composite 10, a gift giver will be able to assemble a complete gift package in a matter of seconds and for less money than it typically costs to individually purchase the gift box, wrapping paper, and greeting card components. As previously described, the gift recipient may also reuse the gift box with greeting card cover element 40 of a greeting card and gift box composite 10, much like a gift bag.

The present invention is also well suited to instances where the gift giver does not handle the package at all, as when an order is placed on line via the Internet. Using common web-based technologies, a merchant could allow the gift giver to select a greeting card and gift box composite 10 with occasion-appropriate indicia 38, then customize the interior message 28 that appears on the interior message card front 26. Thus a merchant could fully and neatly package a complete and personalized gift that is presentable for giving. The low cost and ease of printing interior message cards 19 also makes the present invention an effective means of serving multilingual markets.

It can be appreciated that this manner of construction could be used in a variety of configurations, all equally suitable for gift giving. The construction of the present invention will work equally well with boxes of any shape or size. While particular gift box sizes, shapes, and materials are shown, the present invention anticipates the use of any gift box, where the size and shape of the device can be tailored to suit its particular finished application. The important feature, the integration of both a gift box and a greeting card interior in this manner is the operable feature, not the size or particular shape. Further, any material such as paper-coated cardboard, corrugated cardboard, metal or plastic could be used in the present invention with the same result.

The present allows a gift giver to quickly “wrap” a gift that has a neat and professional appearance with a minimum effort. The present invention also provides a box that is reusable wherein the interior message card is affixed with an easily removable adhesive so that the interior message card can be removed and replaced thereby facilitating the reuse of the gift box with card cover, thus making the present invention an effective use of materials both in its initial manufacture and its ongoing reuse.

Obviously, many modifications and variations of the present invention are possible in light of the above teachings. It is, therefore, to be understood that within the scope of the present application, the present invention may be practiced otherwise than as specifically described.

We claim:

1. A greeting card with gift box composite comprising:
an interior message card;
a gift box having an inside, an outside and a single layer greeting wall;
the single layer greeting wall having an interior surface exposed to the inside of the gift box, an exterior surface exposed to the outside of the gift box, and an integral and contiguous greeting card cover, which greeting card cover when opened creates a greeting wall opening in the greeting wall; and
an attachment means for attaching the interior message card to the interior surface,
so that the greeting card cover can be opened to view the interior message card through the greeting wall opening.

2. The greeting card and gift box composite of claim 1 in which the interior message card is removably attached.

3. The greeting card and gift box composite of claim 2 in which the gift box with greeting card cover can be reused one or more times.

4. The greeting card and gift box composite of claim 3 in which the gift box with greeting card cover can be reused by removing the interior message card and replacing it with another interior message card.

5. The greeting card and gift box composite of claim 2 in which the attachment means is a pressure sensitive adhesive.

6. The greeting card and gift box composite of claim 5 in which the pressure sensitive adhesive is covered with an adhesive shield prior to use.

7. The greeting card and gift box composite of claim 1 in which the interior surface has interior registration arrows for alignment of the interior message card.

8. The greeting card and gift box composite of claim 7 in which the interior message card has interior message card registration arrows for alignment of the interior message card.

9. The greeting card and gift box composite of claim 8 in which the interior message card has no-write margins, and a printed margin border to define the no-write margins.

10. The greeting card and gift box composite of claim 9 which has assembly instructions rendered in the no-write margins so as to be concealed when the interior message card is properly attached to the interior surface.

11. The greeting card and gift box composite of claim 1 in which the interior message card has one or more mounting slits to allow mounting a photograph.

12. The greeting card and gift box composite of claim 1 in which the greeting card cover is die-cut and has breakaway attachment points which hold the greeting card cover in place during manufacture but which can be separated when the greeting card cover is first opened.

13. The greeting card and gift box composite of claim 12 in which the breakaway attachment points are nicks.

14. The greeting card and gift box composite of claim 13 in which the nicks include one or more corner nicks.

15. The greeting card and gift box composite of claim 13 in which the nicks are grouped to create segments of perforation.

16. The greeting card and gift box composite of claim 13 in which the breakaway attachment points form greeting card cover attachment point remnants and greeting wall attachment point remnants when the greeting card cover is opened, which greeting card cover attachment point remnants and greeting wall attachment point remnants interlock when the greeting card cover is closed to form a paper clasp, the paper clasp providing resistance to assist in holding the greeting card cover in place when the gift box with greeting card cover element is reused.

17. The greeting card and gift box composite of claim 12 in which the greeting card cover in the greeting wall is hinge scored to create a hinge to permit the greeting card cover to hingeably pivot about the hinge.

18. The greeting card and gift box composite of claim 12 in which the greeting wall has a finger catch to assist the user in opening the greeting card cover.

19. The greeting card and gift box composite of claim 1 in which there are instructions on the interior surface instructing the user on how to install the interior message card.

20. The greeting card and gift box composite of claim 19 in which the instructions are concealed when the interior message card is affixed.

21. A greeting card and gift box composite comprising:
an interior message card having no-write margins and a printed margin border to define the no-write margins;
a gift box having an inside, an outside and a single layer greeting wall;
the single layer greeting wall having an interior surface exposed to the inside of the gift box, an exterior surface exposed to the outside of the gift box, a finger catch, and a greeting card cover, which greeting card cover when opened creates a greeting wall opening in the greeting wall;
an attachment means for attaching the interior message card to the interior surface;
a plurality of registration arrows for alignment of the interior message card on the interior surface;
so that the interior message card substantially covers the greeting wall opening, and the greeting card cover can be opened to view the interior message card; and
the greeting card cover being die-cut, having breakaway attachment points which hold the greeting card cover during manufacture but which can be separated by opening the greeting card cover, and having a scored line hinge to create a hinge to permit the greeting card cover to hingeably pivot about the hinge.

22. The greeting card and gift box composite of claim 21 in which the attachment means is a pressure sensitive adhesive that removably affixes the interior message card, making the greeting card and gift box composite reusable by replacing the interior message card.
